(19) United States
(12) Patent Application Publication
(10) Pub. No.: US 2020/0043378 A1
(43) Pub. Date: Feb. 6, 2020

(54) INDICATOR OF UNWANTED CONDUCT

(71) Applicant: ZAFARI PATENT IVS, København S. (DK)

(72) Inventor: Darios ZAFARI, København S. (DK)

(21) Appl. No.: 16/485,128

(22) PCT Filed: Feb. 6, 2018
(86) PCT No.: PCT/DK2018/050027

§ 371 Date: Aug. 9, 2019

(30) Foreign Application Priority Data
Feb. 10, 2017 (DK) PA 2017 00101

(51) Int. Cl. G09F 3/00; G09F 3/10

(52) U.S. Cl. CPC G09F 3/0292; G09F 2003/0282; G09F 3/0288; G09F 3/10

(57) ABSTRACT

A tag device (2) for indicating usage of apparel is disclosed. The tag device (2) is configured to be attached to a piece of apparel. The tag device (2) comprises at least one sticker device (4) provided with adhesive covered by a detachably attached bottom foil, wherein the opposite side of the sticker device is covered with a detachably attached top foil, wherein the tag device (2) is configured to be detached from the piece of apparel, wherein the tag device (2) is configured to be deformed when being detached from the piece of apparel.

### FIELD OF INVENTION

The present invention generally relates to a device for indicating usage of apparel or other consumer products and devices. The present invention more particularly relates to a device for preventing unwanted application of apparel or other consumer products and devices by indicating usage and hereby avoid monetary loss by retailers.

### PRIOR ART

To prevent the unwanted conduct, retailers require the purchased items to be returned with the original labels still intact. Due to small labels, which can be hidden inside while customers try the apparel, this does not resolve the unwanted conduct. The customers are still able to wear the apparel or use the products or devices and hereafter return the items.

GB 2506107 A and US 2010/0050487 A1 disclose devices in the form of a strip of material with a fixing element for fixing the ends together. The fixing elements cannot be opened without severing or destroying the strip or the fixing element. The strip loops through openings in the apparel which entail that some of the strip would be visible which prevent customers unwanted conduct before removing the device. Due to the use of strips, the devices must be individually modified to fit the type of product. The modification complicates the use of the devices and makes them more cost-intensive. Furthermore, trying on the apparel will be complicated because of the strip inside the apparel. Customers can collide with the strip which makes it uncomfortable trying on the apparel.

US 2009/0315317 A1 discloses a label having three parts separated by separation lines. Two of the three parts have pull tabs to allow them to be easily removed. The third part is a narrow strip between the separation lines that does not have a pull tab. The label parts with pull tabs can be lifted off a product, thereby leaving the third narrow strip on the product. The narrow strip can be removed by a scraping action which leads to destruction of the narrow strip. Accordingly, it is difficult to reconstruct to the label. In general, there a risk of damaging the product by the scraping action needed to remove the narrow strip.

US 2011/0126439 A1 discloses a sticker comprising a backing layer, a sticker body with a top layer and an adhesive layer, and a security arrangement cutting through the top layer and being stopped at an adhesive layer to ensure the sticker body being completely from the backing layer without tearing the top layer apart. Upon removal of the sticker, the sticker becomes deformed or twisted and is not easily attached again. However, the sticker may not be suited for all purposes due to form and construction which specifically is directed to unauthorised opening of boxes.

Thus, there is a need for a way to eliminate the abovementioned disadvantages of the prior art and a method which enables the retailers to see the usage and hereby avoid monetary loss.

It is an object of the present invention to provide a device configured to prevent customers unwanted conduct without carrying out individual application specific modifications.

It is also an object of the present invention to provide a device that is less expensive than the prior art solutions.

It is a further object of the present invention to provide a device that can be placed on the outside of the apparel, so customers easily and more comfortably can try on the apparel or other consumer products or devices.

### SUMMARY OF THE INVENTION

The object of the present invention can be achieved by a tag device as defined in claim 1. Preferred embodiments are defined in the dependent sub claims, explained in the following description and illustrated in the accompanying drawings.

The tag device according to the invention is a tag device for indicating usage of objects, wherein the tag device is configured to be attached to an object, wherein the tag device comprises:
at least one sticker device provided with adhesive covered by a detachably attached bottom foil,
   wherein the tag device is configured to be detached from the object,

wherein the tag device becomes deformed when being detached from the object, and

wherein the sticker device is provided with one or more carved patterns separating the sticker device in two or more portions that are arranged in such a manner that the portions are displaced relative to each other during removal of the sticker device.

Hereby, it is possible to provide a device configured to prevent customers unwanted conduct of an object without carrying out individual application specific modifications.

It is also possible to provide a device that is less expensive than the prior art solutions. Moreover, it is possible to provide a tag device that can be placed at the outside of an apparel so that customers easily and more comfortably can try on the apparel or other consumer products or devices.

It may be an advantage that the opposite side of the sticker device is covered with a detachably attached top foil.

In one embodiment, the tag device according to the invention is a tag device for indicating usage of apparel. The tag device may, however, also be used to indicate usage of other products having a surface onto which it is possible to attach the tag device.

The tag device is configured to be attached to an object (e.g. a piece of apparel) and the tag device comprises:
at least one sticker device provided with adhesive covered by a detachably attached bottom foil, wherein the opposite side of the sticker device optionally may be covered with a detachably attached top foil.

The sticker device can be a sticker having any suitable size and geometry. The sticker device may be a security sticker or a garment security sticker.

The tag device is not limited to be attached to a piece of apparel. The tag device may be attached to a bottle, a box, a container or other objects.

The sticker may have any suitable size and geometry and the adhesive may have any suitable size and thickness.

The tag device is configured to be detached from the object (e.g. a piece of apparel) in a manner in which the tag device is deformed during removal. By the term deformed is meant that one or more structures of the tag device are deformed during the detachment in such a manner that the at least one sticker device is either broken (at least partly ruptured or permanently elongated) or displaced relative to other structures of the tag device.

The sticker device is provided with one or more carved patterns separating the sticker device in two or more portions that are arranged in such a manner that the portions are displaced relative to each other during removal of the sticker device.

Hereby, it is possible to produce a simple and cheap tag device.

It may be beneficial that the sticker device comprises a plurality of zigzag patterns.

Hereby it is possible to provide a simple sticker device that is either broken (at least partly ruptured or permanently elongated) or displaced relative to other structures of the tag device when being detached.

It may be advantageous that the zigzag patterns are arranged adjacent to each other. Hereby it is easy to visually detect if the zigzag patterns are broken or displaced relative to other structures of the tag device when being detached.

In one embodiment of the invention, the zigzag patterns constitute a carved pattern arranged in two parallel rows. The tag device can be detached from the piece of apparel in a manner in which the sticker device is being deformed.

It may be beneficial that the sticker device is provided with a plurality of closed carved patterns, wherein at least some of the closed carved patterns are overlapping each other.

Hereby it is easy to visually detect if the closed carved patterns are broken or displaced relative to other structures of the tag device when being detached.

It may be advantageous that the closed carved patterns are closed loops such as circles or oval patterns or polygonal patterns.

Hereby, it is possible to produce the tag device by means of a punching process.

It may be beneficial that the closed carved patterns are arranged in one or more rows. Hereby, it is easy to compare the rows in order to determine if the tag device has been removed and attached.

It may be advantageous that the sticker device comprises a number of first portions and a number of second portions, wherein the second portions have a thickness which is smaller than the thickness of the first portions.

Hereby, it is possible to provide the sticker device with “weak” areas that easily will break or be deformed during detachment of the sticker device.

It may be beneficial that the thickness of the first portions is more than twice as large as the thickness of the second portions.

Hereby, the sticker device can easily break or be deformed during detachment of the sticker device.

It may be an advantage that the sticker device comprises a first area with a first thickness of adhesive and a second area with a smaller thickness of adhesive.

Hereby, it is possible to force the sticker device to deform due to the vibration with respect to adhesiveness.

It may be advantageous that the sticker device is shaped as a structure that comprises one or more structures that are not dimensionally stable when the sticker device is detached from an object (e.g. a piece of apparel).

Hereby, it is possible to provide a simple and easily producible tag device.

It may be beneficial that the tag device comprises a first separate sticker device and a second separate sticker device, wherein the first separate sticker device is configured to be attached to the object (e.g. a piece of apparel), wherein the first separate sticker device comprises a centrally arranged portion and one or more connection portions, wherein the one or more connection portions are narrower than the centrally arranged portion, wherein the second separate sticker device is configured to be attached on the top of and hereby cover the centrally arranged portion of the first separate sticker device, whereby the one or more connection portions protrude from the centrally arranged portion when the second separate sticker device is attached on the top of and covers the centrally arranged portion.

Hereby, it is possible to provide an easily producible tag device that is easy to detach and makes it possible to detect if the tag device has been removed and attached afterwards.

### DESCRIPTION OF THE DRAWINGS

The invention will become more fully understood from the detailed description given herein below. The accompanying drawings are given by way of illustration only, and thus, they are not limitative of the present invention. In the accompanying drawings:

FIG. 1A shows a schematic side view of a tag device according to the invention provided with a protective foil member;

FIG. 1B shows a schematic side view of the tag device shown in FIG. 1A in a configuration in which the protective foil member has been removed;

FIG. 1C shows a schematic side view of the tag device shown in FIG. 1B attached to a piece of apparel;

FIG. 1D shows a schematic side view of the tag device shown in FIG. 1C, in which the top foil is being removed;

FIG. 1E shows a schematic side view of the tag device shown in FIG. 1D being detached from the apparel;

FIG. 2A shows a schematic top view of a tag device according to the invention;

FIG. 2B shows a schematic top view of another tag device according to the invention;

FIG. 2C shows a schematic top view of a further tag device according to the invention;

FIG. 3A shows a schematic front view of a shirt with a tag device according to the invention;

FIG. 3B shows a schematic front view of the tag device shown in FIG. 3A being detached;

FIG. 3C shows a schematic close-up view of the tag device shown in FIG. 3B being detached;

FIG. 3D shows a schematic front view of the tag device that has been detached from the shirt being attached to the shirt;

FIG. 3E shows a schematic close-up view of the tag being attached to the shirt;

FIG. 4A shows a schematic top view of a tag device according to the invention;

FIG. 4B shows a schematic top view of the tag device shown in FIG. 4A in another configuration;

FIG. 4C shows a schematic top view of another tag device according to the invention;

FIG. 4D shows a schematic top view of a further tag device according to the invention;

FIG. 5A shows a schematic side view of a tag device according to the invention;

FIG. 5B shows a schematic side view of the tag device shown in FIG. 5A;

FIG. 5C shows a schematic side view of a tag device according to the invention;

FIG. 5D shows a schematic side view of the tag device shown in FIG. 5C in a configuration in which the end portion of the sticker device is deformed and thus broken;

FIG. 6A shows a schematic top view of a tag device according to the invention;

FIG. 6B shows a schematic top view of the tag device shown in FIG. 6A in a configuration in which the first sticker device is attached to a piece of apparel;

FIG. 6C shows a schematic top view of the tag device shown in FIG. 6B in a configuration in which a force is applied to pull the end portion of the rectangular portion of the second sticker device;

FIG. 6D shows a schematic top view of the tag device shown in FIG. 6C in a configuration in which the end portion of the rectangular portion of the second sticker device has been pulled to such an extent that the connection portions are plastically deformed;

FIG. 7A shows a schematic top view of a tag device according to the invention;

FIG. 7B shows a schematic top view of another tag device according to the invention;

FIG. 7C shows a schematic top view of a further tag device according to the invention;

FIG. 8A shows a schematic top view of a tag device according to the invention;

FIG. 8B shows a schematic top view of another tag device according to the invention and

FIG. 8C shows a schematic top view of a further tag device according to the invention;

FIG. 9A shows a schematic view of a tag device according to the invention attached to a door and the frame surrounding it;

FIG. 9B shows a schematic, perspective view of a tag device according to the two parts of a closed box;

FIG. 9C shows a schematic view of a tag device according to the invention attached to a bottle;

FIG. 9D shows a schematic view of a tag device according to the invention attached to a cup and

FIG. 9E shows a schematic view of a tag device according to the invention attached to a tube.

### DETAILED DESCRIPTION OF THE INVENTION

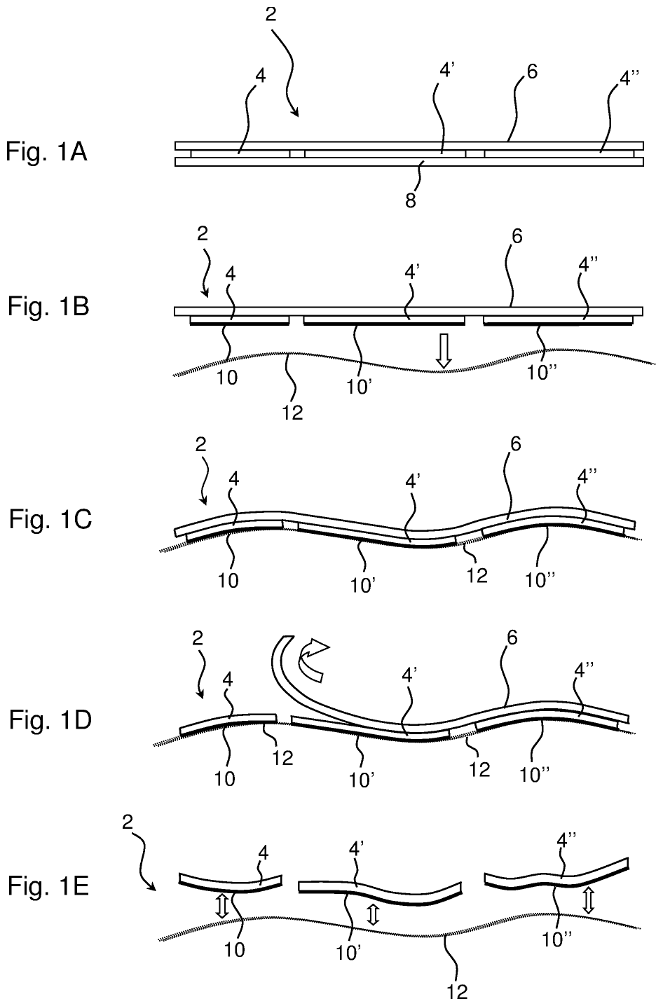

Referring now in detail to the drawings for the purpose of illustrating preferred embodiments of the present invention, a tag device 2 of the present invention is illustrated in FIG. 1A.

FIG. 1A illustrates a schematic side view of a tag device 2 according to the invention provided with a protective foil member 8 attached to the adhesive side of three sticker devices 4, 4′, 4″ of the tag device 2. The sticker devices 4, 4′, 4″ are separated from each other and have basically the same size. It is, however, possible to apply sticker devices 4, 4′, 4″ of different sizes.

The tag device 2 comprises a top foil 6 attached to the top side of the sticker devices 4, 4′, 4″. The bottom surface of the top foil 6 is provided with adhesive for allowing the top foil 6 to be detachably attached to the top side of the sticker devices 4, 4′, 4″.

FIG. 1B illustrates a schematic side view of the tag device 2 shown in FIG. 1A in a configuration in which the protective foil member 8 has been removed. The tag device 2 is arranged above a curved fabric of a piece of apparel 12. The tag device 2 is being moved downwards towards the piece of apparel 12 like indicated with the arrow.

It can be seen that the bottom side of the sticker devices 4, 4′, 4″ are provided with adhesive 10, 10′, 10″. Accordingly, each of the sticker devices 4, 4′, 4″ can be removably attached to the piece of apparel 12 (like shown in FIG. 1C).

FIG. 1C illustrates a schematic side view of the tag device 2 shown in FIG. 1B attached to the piece of apparel 12 shown in FIG. 1B. Each of the sticker devices 4, 4′, 4″ have been brought into contact with the piece of apparel 12. Accordingly, each of the sticker devices 4, 4′, 4″ are removably attached to the piece of apparel 12.

FIG. 1D illustrates a schematic side view of the tag device 2 shown in FIG. 1C, in which the top foil 6 is being removed. Each of the sticker devices 4, 4′, 4″ is attached to the piece of apparel 12 while the top foil 6 is being removed (indicated by an arced arrow). The top foil 6 may be removed with the fingers.

FIG. 1E shows a schematic side view of the tag device 2 shown in FIG. 1D being detached from the apparel 12. Accordingly, the three sticker devices 4, 4′, 4″ are no longer attached to the apparel 12. If the user of the apparel 12 tries to attach the three sticker devices 4, 4′, 4″ to the apparel 12 again, it would be very difficult, and thus in practice impossible to attach the apparel 12 three sticker devices 4, 4′, 4″ in the original configuration because there are no means for securing that the distances between the three sticker devices 4, 4′, 4″ correspond to the original distances. Therefore, the tag device 2 can only be removed from the apparel 12 and afterwards be attached again in a manner in which it is possible to visually detect that the configuration of the sticker devices 4, 4′, 4″ differs from the original configuration.

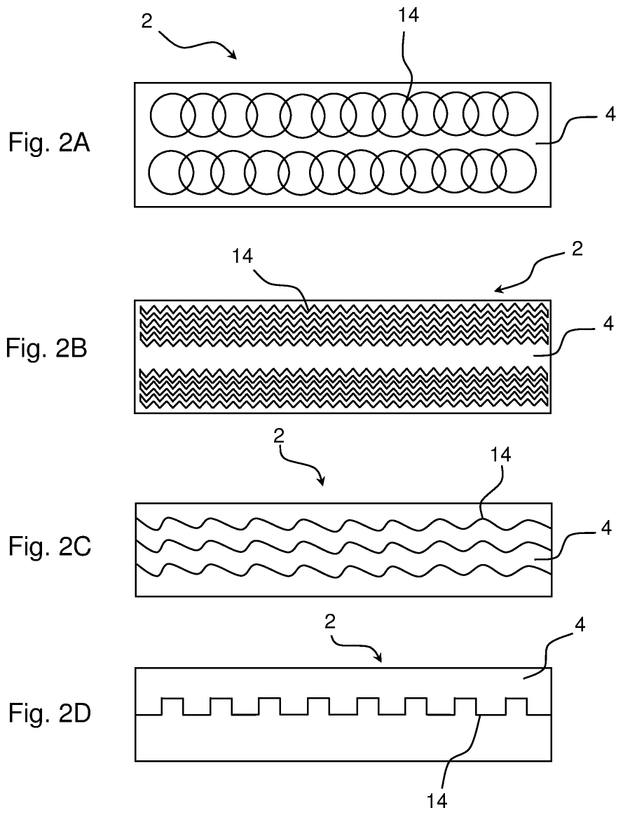

FIG. 2A illustrates a schematic top view of a tag device 2 according to the invention. The tag device 2 comprises a sticker device 4 provided with a plurality of circles constituting a carved pattern 14. The circles are arranged in two rows. The circles in each row are overlapping. The tag device 2 is configured to be detached from the piece of apparel in a manner in which the sticker device 4 is being deformed.

FIG. 2B illustrates a schematic top view of another tag device 2 according to the invention. The tag device 2 comprises a sticker device 4 provided with a plurality of zigzag patterns 14 arranged adjacent to each other. The zigzag patterns constitute a carved pattern 14 arranged in two parallel rows. The tag device 2 can be detached from the piece of apparel in a manner in which the sticker device 4 is being deformed.

FIG. 2C illustrates a schematic top view of a further tag device 2 according to the invention. The tag device 2 comprises a sticker device 4 provided with a plurality of wave-shaped patterns 14 arranged adjacent to each other. The tag device 2 can be detached from the piece of apparel in a manner in which the sticker device 4 is being deformed.

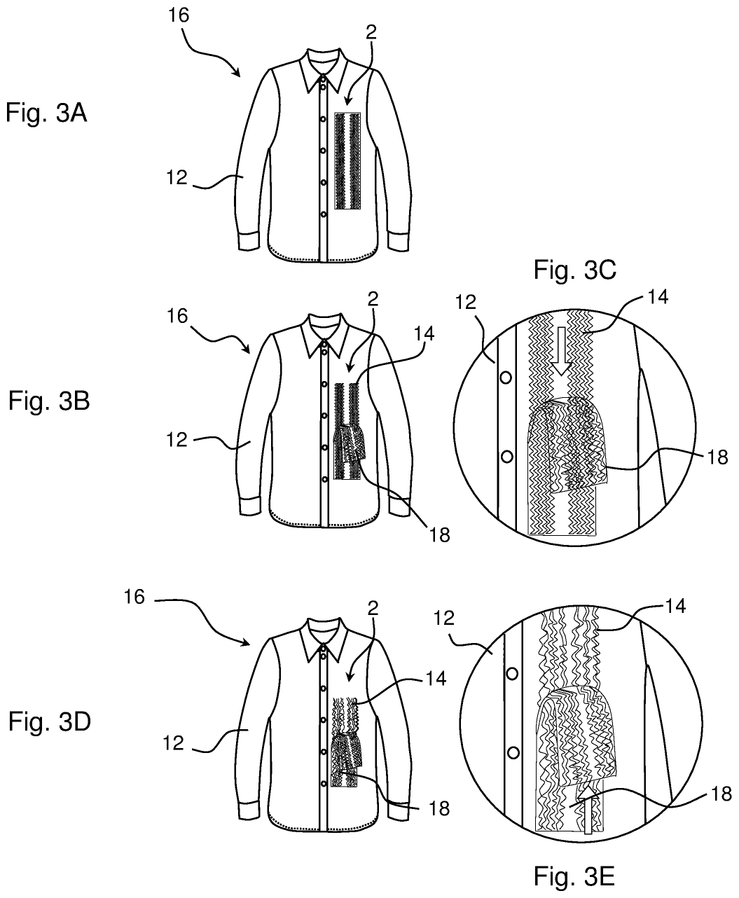

FIG. 3A illustrates a schematic front view of a shirt 16 with a tag device 2 according to the invention. The shirt 16 is made of fabric and is provided with an elongated tag device 2 detachably attached to the front side of the shirt 16. The tag device 2 is very large and therefore the user of the shirt 16 may desire to remove the tag device 2 and put on the shirt to a party or a meeting. However, as will be explained with reference to the following figures, the tag device 2 enables the shop from which the shirt 16 is bought to detect if the tag device 2 has been removed.

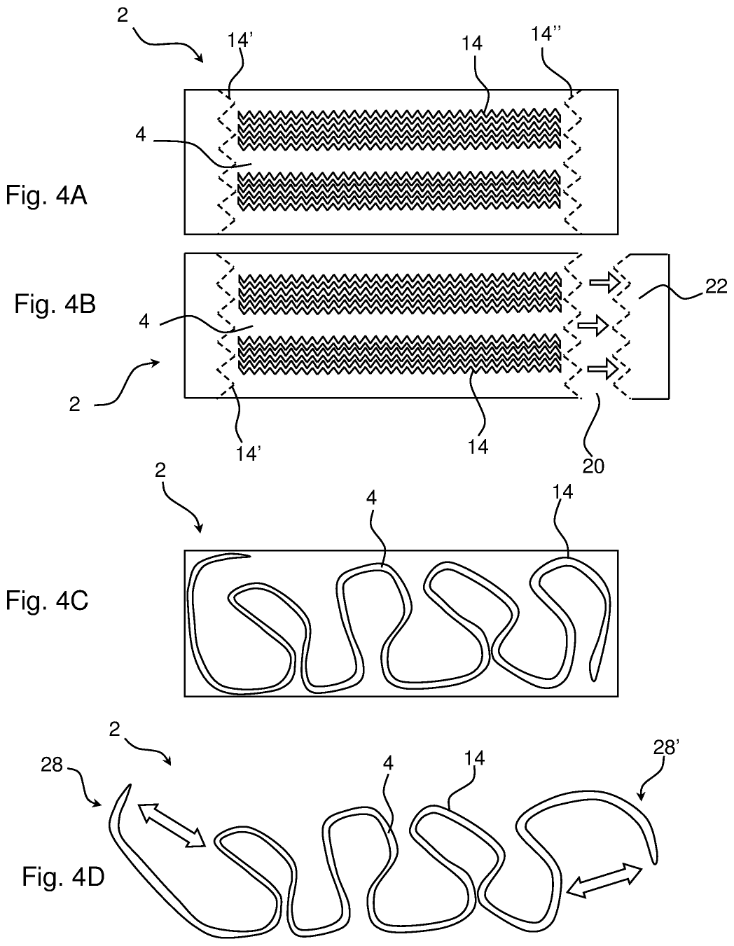

FIG. 3B shows a schematic front view of how the tag device 2 (shown in FIG. 3A) is deformed and thus broken during removal from the apparel 16 (formed as a shirt 12). The tag device 2 comprises a sticker device 18 provided with a carved pattern 14. The sticker device 18 is deformed during detachment because of the adhesive connection to the apparel 12. When the user of the apparel 12 removes the tag device 2 form the apparel 12 (as shown in FIG. 4B), the detached sticker device 18 is deformed or/and damaged because the carved pattern 14 comprises thin structures that are not dimensionally stable when detached from the surface on which they are attached.

Therefore, the tag device 2 can only be removed from the apparel 12 and afterwards be attached again in a way it is possible to visually detect that the configuration of the sticker device differs from the original configuration.

FIG. 3C shows a close-up illustration of a portion of the tag device shown in FIG. 3B. It can be seen that a section of the sticker device 18 is moved downwards as indicated with an arrow. The sticker device 18 also comprises two parallel arranged sections comprising zigzag-shaped carved patterns 14. These zigzag-shaped carved patterns 14 are still attached to the shirt 12 and need to be detached afterwards. Therefore, the sticker device 18 comprises several separated sections arranged in specific predefined positions relative to each other. Accordingly, a reconstruction (attachment) of the several separated sections is impossible in practice. Furthermore, the thin zigzag-shaped carved patterns 14 tend to break or be plastically elongated due to the relative large (compared with the yield strength of the carved patterns at which plastic deformation begins) forces applied to detach the sticker device 18.

FIG. 3D illustrates a schematic front view of the shirt 16 and tag device 2 shown in FIG. 3B, in a configuration in which the user of the shirt 12 has attached the tag device 2 to the shirt 12. FIG. 3E illustrates a close-up view of a section of the tag device 2 shown in FIG. 3D.

It can be seen that, in practice, it is impossible to re-attach the tag device 2 in the original configuration, because there are no means for securing that the deformed or/and damage detached sticker device 18 can be positioned in a configuration corresponding to the original configuration.

The carved patterns 14 have been attached to the shirt 12. However, this section does no longer form the original zigzag-pattern as shown in FIG. 3C. Additionally, another section of the sticker device is being attached in an upward direction as indicated by the arrow. This section of the sticker device 18 is bears the mark of deformation during the detachment procedure.

Therefore, the tag device 2 can only be removed from the apparel 12 and afterwards be attached again in a manner in which it is possible to visually detect that the configuration of the tag devices 2 differ from the original configuration.

FIG. 4A illustrates a schematic top view of a tag device 2 according to the invention attached to a piece of apparel (not shown). The tag device 2 is rectangular-shaped and comprises a sticker device and a plurality of carved patterns 14 formed as zigzag-shaped cutting lines 14 extending parallel to each other. The tag device 2 furthermore comprises a first sectional carved pattern 14′ and a second sectional carved pattern 14″. The sectional carved patterns 14′, 14″ are zigzag-shaped but may be shaped differently.

FIG. 4B illustrates a schematic top view of the tag device 2 shown in FIG. 4A in a configuration, in which an end portion 22 constituting a separated portion 22 is separated from the remaining portion of the sticker device 4 of the tag device 2. Accordingly, a space 20 is established between the separated portion 22 and the remaining portion of the tag device 2. The separation of the separated portion 22 and the remaining portion of the tag device 2 may be caused by removal of the tag device 2. When the tag device 2 is being removed from the piece of apparel (not shown) that it is attached to, the different portions of the tag device 2 will be separated from each other because of the cutting lines 14′, 14″.

FIG. 4C illustrates a schematic top view of a further tag device 2 according to the invention. The tag device 2 comprises a sticker device 4 provided with a carved pattern 14 constituting a thin, twisted geometry.

FIG. 4D illustrates a schematic top view of the tag device 2 shown in FIG. 4C in a configuration in which the tag device 2 has been removed from a surface (e.g. a piece of apparel). It can be seen that the first end portion 22 and the second end portion 28′ of the sticker device 4 of the tag device 2 is deformed (displaced relative to the central portion of the sticker device 4) compared to the original orientation (shown in FIG. 4C). Accordingly, it is very difficult and in practice impossible to attach the tag device 2 to a surface once it has been removed from the surface.

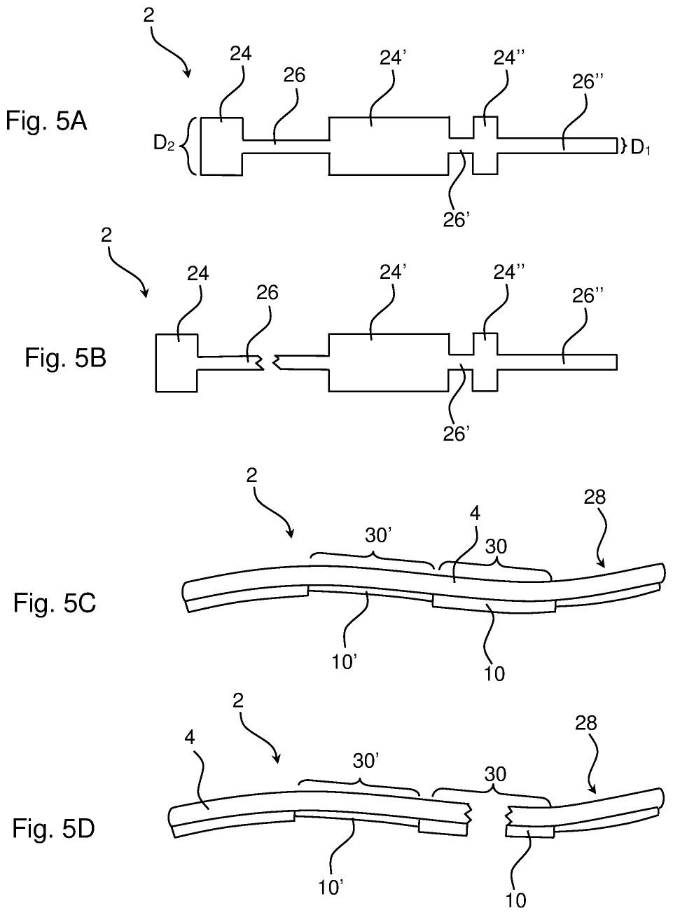

FIG. 5A illustrates a schematic side view of a tag device 2 according to the invention. The tag device 2 comprises a first thick portion 24, a second thick portion 24′ and a third thick portion 24″ as well as a first thin portion 26, a second thin portion 26′ and a third thin portion 26″. The thickness D₁ of the thin portions as well as the thickness D₂ of the thick portions are indicated.

FIG. 5B illustrates a schematic side view of the tag device 2 shown in FIG. 5A. The tag device 2 has been removed from a surface (e.g. a piece of apparel) and during the removal the first thin portion 26 has been deformed and has broken. Accordingly, the tag device 2 cannot be attached to a surface (e.g. a piece of apparel) in a manner in which the thin and thick portions 24, 24′, 24″, 26′, 26′, 26″ are arranged as shown in FIG. 5A. Accordingly, in practice it is impossible to attach the tag device 2 to a surface once it has been removed from the surface.

FIG. 5C illustrates a schematic side view of a tag device 2 according to the invention. The tag device 2 comprises a sticker device having a first area 30 provided with a thick adhesive layer 10 and a second area 30′ provided with a thinner layer of adhesive 10′. The tag device 2 comprises an end portion 28.

FIG. 5D illustrates a schematic side view of the tag device 2 shown in FIG. 5C in a configuration in which the end portion 28 of the sticker device 4, during removal from a surface, is deformed and thus broken due to the large adhesiveness of the thick adhesive layer 10.

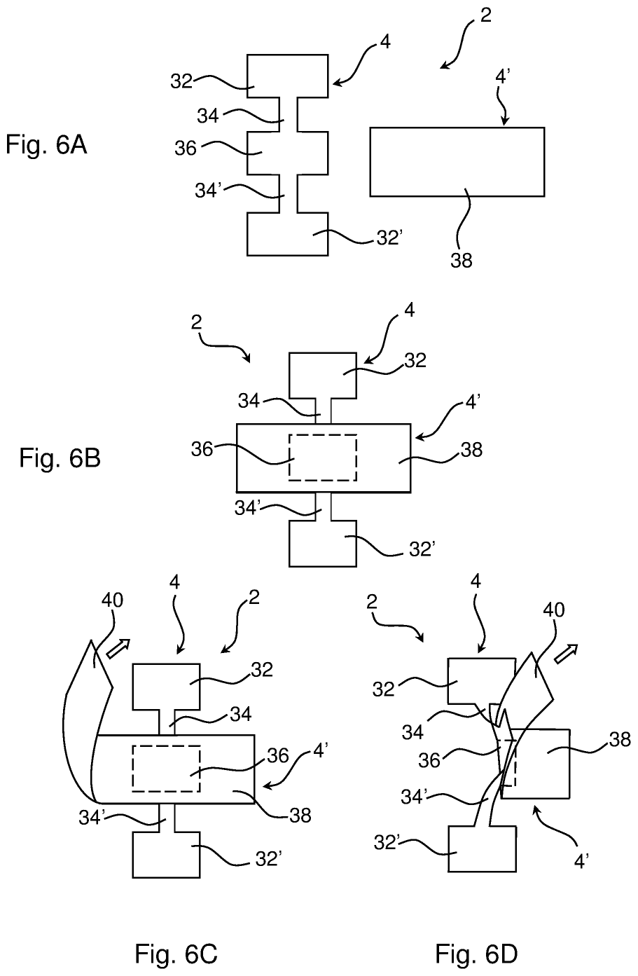

FIG. 6A illustrates a schematic top view of a tag device 2 according to the invention. The tag device 2 comprises a first sticker device 4 comprising a first portion 32, a second portion 32′ and a third centrally arranged portion 36. A first connection portion 34 is provided between the first portion 32 and the second portion 32′. Similarly, a second connection portion 34′ is provided between the centrally arranged portion 36 and the second portion 32′. The tag device 2 additionally comprises a second sticker device 4′ comprising a rectangular portion 38. The connection portions 34, 34′ are narrower than the first portion 32, the second portion 32′ and the third centrally arranged portion 36. Accordingly, the connection portions 34, 34′ are deformable when subjected to traction forces during removal of the second sticker device 4′ attached to and therefore pulling the centrally arranged portion 36 of the first sticker device 4.

FIG. 6B illustrates a schematic top view of the tag device 2 shown in FIG. 6A in a configuration in which the first sticker device 4 is attached to a piece of apparel (not shown) and the second sticker device 4′ is attached on the top of the first sticker device 4. The centrally arranged portion 36 (arranged under the second sticker device 4′) is indicated by a dotted line.

FIG. 6C illustrates a schematic top view of the tag device 2 shown in FIG. 6B in a configuration in which a force is applied to pull the end portion 40 of the rectangular portion 38 of the second sticker device 4′.

FIG. 6D illustrates a schematic top view of the tag device 2 shown in FIG. 6C in a configuration in which the end portion 40 of the rectangular portion 38 of the second sticker device 4′ has been pulled to such an extent that the connection portions 34, 34′ are plastically deformed. Hereby, it is possible to see if the sticker device 4 is attached to the piece of apparel (not shown).

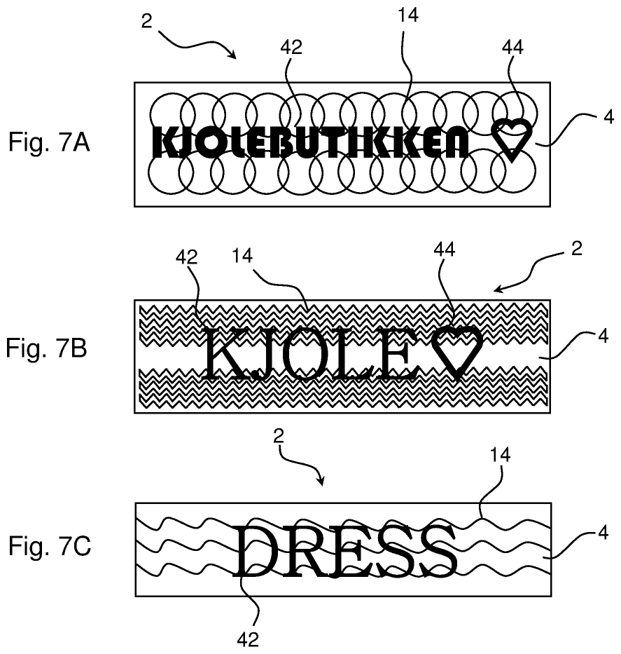

FIG. 7A illustrates a schematic top view of a tag device 2 according to the invention. The tag device 2 comprises a sticker device 4 provided with a plurality of circles constituting a carved pattern 14. The circles are arranged in two rows. The circles in each row are overlapping. The sticker device 4 is provided with a text-shaped pattern: “KJOLEBUTIKKEN” comprising a number of letters 42 followed by a heart symbol 44. Accordingly, it is possible to provide any desired text and symbol on the sticker device 4. The tag device 2 is configured to be detached from the piece of apparel in a manner in which the sticker device 4 is being deformed.

FIG. 7B illustrates a schematic top view of another tag device 2 according to the invention. The tag device 2 comprises a sticker device 4 provided with a plurality of zigzag patterns 14 arranged adjacent to each other. The zigzag patterns constitute a carved pattern 14 arranged in two parallel rows. The sticker device 4 is provided with a text-shaped pattern: “KJOLE” comprising a number of letters 42 followed by a heart symbol 44. The tag device 2 can be detached from the piece of apparel in a manner in which the sticker device 4 is being deformed.

FIG. 7C illustrates a schematic top view of a further tag device 2 according to the invention. The tag device 2 comprises a sticker device 4 provided with a plurality of wave-shaped patterns 14 arranged adjacent to each other. The sticker device 4 is provided with a text-shaped pattern: “DRESS” comprising a number of letters 42. The tag device 2 can be detached from the piece of apparel in a manner in which the sticker device 4 is being deformed.

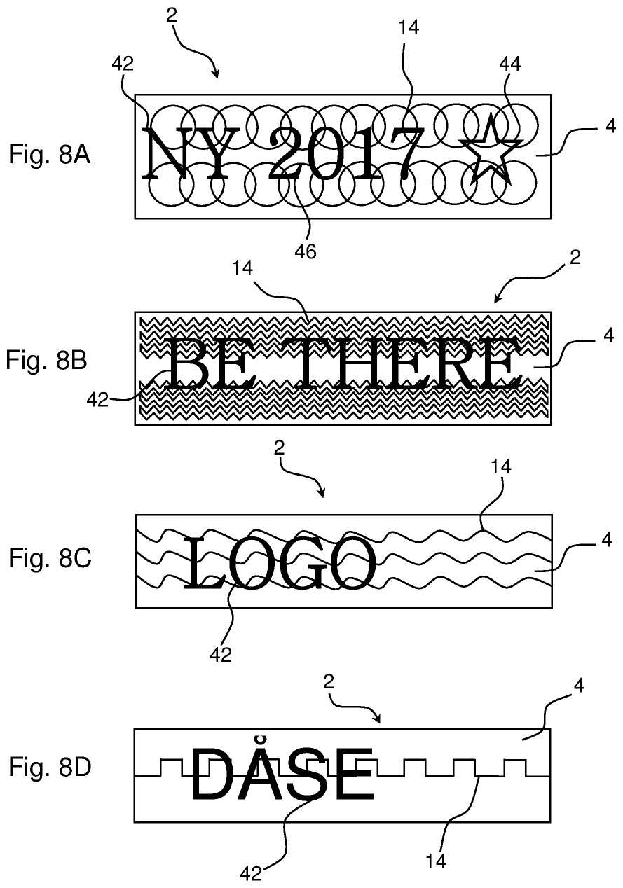

FIG. 8A illustrates a schematic top view of a tag device 2 according to the invention. The tag device 2 comprises a sticker device 4 provided with a plurality of circles constituting a carved pattern 14, wherein the circles are arranged in two rows. The circles in each row are overlapping and the sticker device 4 is provided with a text-shaped pattern: “NY 2017” comprising a number of letters 42 and the numbers 46 followed by a star symbol 44. Accordingly, it is possible to provide any desired letter, number and symbol on the sticker device 4. The tag device 2 is configured to be detached from the piece of apparel in a manner in which the sticker device 4 is being deformed.

FIG. 8B illustrates a schematic top view of another tag device 2 according to the invention. The tag device 2 comprises a sticker device 4 provided with a plurality of zigzag patterns 14 arranged adjacent to each other, wherein the zigzag patterns constitute a carved pattern 14 arranged in two parallel rows. The sticker device 4 is provided with a text-shaped pattern: “BE THERE” comprising a number of letters 42. The tag device 2 can be detached from the piece of apparel in a manner in which the sticker device 4 is being deformed.

FIG. 8C illustrates a schematic top view of a further tag device 2 according to the invention. The tag device 2 comprises a sticker device 4 provided with a plurality of wave-shaped patterns 14 arranged adjacent to each other. The sticker device 4 is provided with a text-shaped pattern: “LOGO” comprising a number of letters 42. This text-shaped pattern: “LOGO” may be replaced by any desirable logo. The logo may include letters, symbols and numbers. Hereby, it is possible to individually design the sticker device 4. The tag device 2 can be detached from the piece of apparel in a manner in which the sticker device 4 is being deformed.

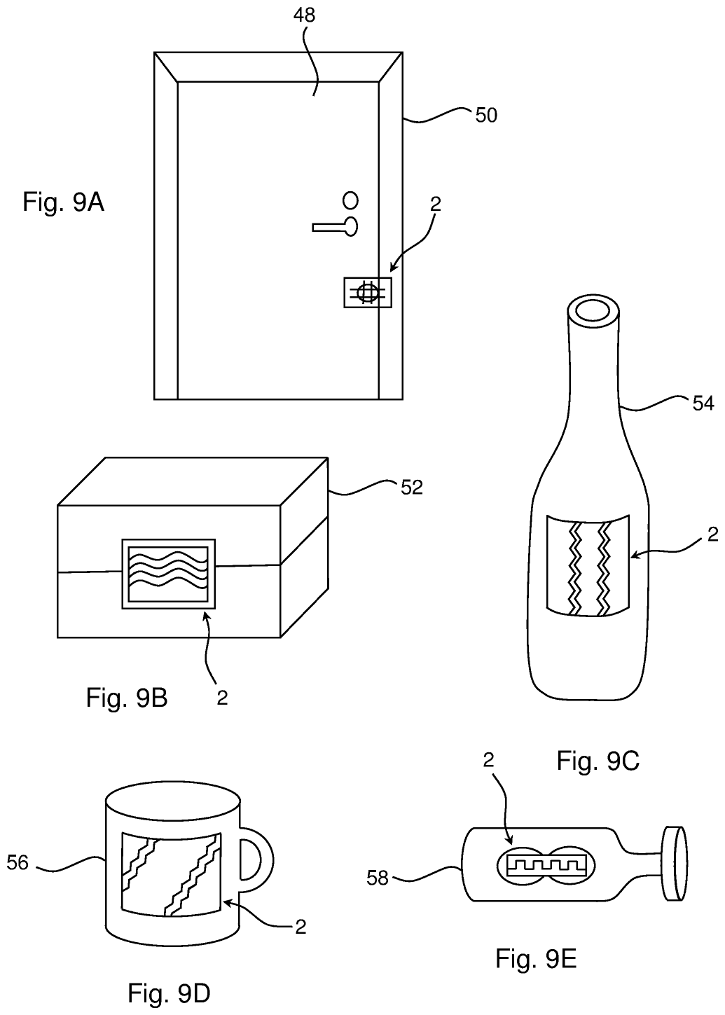

FIG. 9A illustrates a schematic view of a tag device 2 according to the invention attached to a door 48 and the frame 50 surrounding it. The tag device 2 is covering the area at which the door 48 and the frame 50 are joint. Accordingly, when the door 48 is opened, the tag device 2 will be torn apart. Thus, the tag device 2 will reveal if the door has been opened.

FIG. 9B illustrates a schematic, perspective view of a tag device 2 according to the two parts of a closed box 52 comprising an upper part and a lower part. The tag device 2 is covering the joining area of the upper part and the lower part. Accordingly, when the box 52 is opened, the tag device 2 will be torn apart and the tag device 2 will reveal if the box 52 has been opened.

FIG. 9C illustrates a schematic view of a tag device 2 according to the invention attached to a bottle 54.

FIG. 9D illustrates a schematic view of a tag device 2 according to the invention attached to a cup 56, and FIG. 9E illustrates a schematic view of a tag device 2 according to the invention attached to a tube 58.

### LIST OF REFERENCE NUMERALS

2 Tag device
4, 4′, 4″ Sticker device
6 Top foil
8 Bottom foil
10, 10′, 10″ Adhesive
12 Fabric or other material
14, 14′, 14″ Carved pattern
16 Apparel
18 Sticker device
20 Space
22 Separated portion
24, 24′, 24″ Thick portion
26, 26′, 26″ Thin portion
28, 28′ End portion
30, 30′ Area
D₁, D₂ Thickness
32, 32′, 36 Portion
34, 34′ Connection portion
36 Centrally arranged portion
38 Rectangular portion
40 End portion
42 Letter
44 Symbol
46 Number
48 Door
50 Frame
52 Box
54 Bottle
56 Cup
58 Tube

1. A tag device for indicating usage of objects, wherein the tag device is configured to be attached to an object, characterised in that the tag device comprises:
at least one sticker device provided with adhesive covered by a detachably attached bottom foil,
wherein the tag device is configured to be detached from the object,
wherein the tag device is being deformed when being detached from the object, and
wherein the sticker device is provided with one or more carved patterns separating the sticker device in two or more portions that are arranged in such a manner that the portions are displaced relative to each other during removal of the sticker device.

2. A tag device according to claim 1, characterised in that the tag device is configured to be attached to a piece of apparel.

3. A tag device according to claim 1, characterised in that the sticker device is provided with a plurality of zigzag patterns.

4. A tag device according to claim 1, characterised in that the sticker device is provided with a plurality of closed carved patterns, wherein at least some of the closed carved patterns are overlapping each other.

5. A tag device according to claim 4, characterised in that the closed carved patterns are closed loops such as circles or oval patterns or polygonal patterns.

6. A tag device according to claim 4, characterised in that the closed carved patterns are arranged in one or more rows.

7. A tag device according to claim 1, characterised in that the sticker device comprises a number of first portions and a number of second portions, wherein the second portions have a thickness that is smaller than the thickness of the first portions.

8. A tag device according to claim 1, characterised in that the sticker device comprises a first area with a first thickness of adhesive and a second area with a smaller thickness of adhesive.

9. A tag device according to claim 1, characterised in that the sticker device is shaped as a structure that comprises one or more structures that are not dimensionally stable when the sticker device is detached from an object.

10. A tag device according to claim 1, characterised in that the tag device comprise a first separate sticker device and a second separate sticker device, wherein the first separate sticker device is configured to be attached to the object, wherein the first separate sticker device comprises a centrally arranged portion and one or more connection portions, wherein the one or more connection portions are narrower than the centrally arranged portion, wherein the second separate sticker device is configured to be attached on the top of and hereby cover the centrally arranged portion of the first separate sticker device, whereby the one or more connection portions protrude from the centrally arranged portion when the second separate sticker device is attached on the top of and covers the centrally arranged portion.

11. A tag device according to claim 9, the object being a piece of apparel.

12. A tag device according to claim 10, the object being a piece of apparel.
